(19) United States
(12) Patent Application Publication
(10) Pub. No.: US 2025/0263825 A1
(43) Pub. Date: Aug. 21, 2025

(54) METHOD FOR MANUFACTURING ALLOY RIBBON PIECE

(71) Applicant: TOYOTA JIDOSHA KABUSHIKI KAISHA, Toyota-shi (JP)

(72) Inventors: Masaaki Ito, Anjo-shi (JP); Motoki Hiraoka, Toyota-shi (JP); Kensuke Komori, Toyota-shi (JP); Yusuke Onitsuka, Toyota-shi (JP); Takuya Nomura, Kasugai-shi (JP)

(73) Assignee: TOYOTA JIDOSHA KABUSHIKI KAISHA, Toyota-shi (JP)

(21) Appl. No.: 19/023,714

(22) Filed: Jan. 16, 2025

(30) Foreign Application Priority Data
Feb. 19, 2024 (JP) 2024-022678

(51) Int. Cl. C22C 45/02; C22C 33/00

(52) U.S. Cl. CPC C22C 45/02; C22C 33/003

(57) ABSTRACT

A method for manufacturing an alloy ribbon piece containing a nanocrystalline alloy includes: preparing an alloy ribbon containing an FeNiB-based amorphous alloy; heating a processing planned portion at a circumference of a crystallization planned portion that is an area in which the alloy ribbon piece is punched of the alloy ribbon to a first temperature range in which crystal grains of αFe and crystal grains of Fe₂B deposit to cause the crystal grains of αFe and the crystal grains of Fe₂B to deposit, and simultaneously heating the crystallization planned portion to a second temperature range of a crystallization starting temperature or higher and lower than the first temperature range to crystallize the crystallization planned portion; and punching an area including the crystallization planned portion from the alloy ribbon by shearing the processing planned portion of the alloy ribbon after the thermal processing step to form the alloy ribbon piece.

### CROSS REFERENCE TO RELATED APPLICATIONS

The present application claims priority from Japanese patent application JP 2024-022678 filed on Feb. 19, 2024, the entire content of which is hereby incorporated by reference into this application.

### BACKGROUND

### Description of Related Art

The present disclosure relates to a method for manufacturing an alloy ribbon piece containing a nanocrystalline alloy.

### Background Art

Conventionally, soft magnetic materials are used for a core (iron core) of a motor of hybrid vehicles (HEV: Hybrid Electric Vehicle), electric vehicles (BEV: Battery Electric Vehicle), and the like. The soft magnetic materials are required to have high magnetization (high torque) and low coercive force (low loss). As a soft magnetic material, a magnetic steel sheet is typically used, but the magnetic steel sheet has a limitation in reduction of loss. Generally, in Fe (iron) based soft magnetic materials, such as a magnetic steel sheet, the smaller the plate thickness is, and/or the smaller the particle size of crystal grain of αFe in a material is, the loss is reduced. In view of this, recently, there is a nanocrystalline alloy ribbon (alloy ribbon containing a nanocrystalline alloy) expected as a soft magnetic material capable of having both high magnetization and low coercive force. The nanocrystalline alloy ribbon is obtained by producing an amorphous alloy ribbon (alloy ribbon containing an amorphous alloy) having a small plate thickness by a liquid quenching method and crystallizing the amorphous alloy ribbon by rapid thermal processing to cause nanocrystalline grains of αFe to deposit.

Meanwhile, when a soft magnetic material is used for a core of a motor or the like, the core or the like is configured of a laminate obtained by producing a plate material in a desired shape by a process of a punching work or the like performed on a plate material of the soft magnetic material and stacking and fixing a plurality of the plate materials. As a technique relating to a method for producing a plate material in a desired shape of a soft magnetic material containing an amorphous alloy ribbon, a nanocrystalline alloy ribbon, or the like, for example, there has been known a method in which a laminate is prepared by stacking a plurality of metal plates (plate material of a soft magnetic material) for a core, and then the laminate is pressed with a temperature gradient provided to the laminate, and the temperature gradient of the laminate is removed after the pressing (JP 2020-47831 A). Further, a composite magnetic ribbon (plate material of a soft magnetic material) excellent in press workability of a punching work or the like and a manufacturing method thereof has been known (JP 2003-163486 A).

### SUMMARY

The nanocrystalline alloy ribbon is possibly broken like a thin glass because of a fragile interface between nanocrystalline grains of αFe and an amorphous alloy phase, and therefore, it is difficult to perform processing, such as a punching work, including deformation of a material. In view of this, it is difficult to manufacture a nanocrystalline alloy ribbon piece (alloy ribbon piece containing a nanocrystalline alloy) as a plate material having a desired shape of a soft magnetic material by performing a punching work on a nanocrystalline alloy ribbon. On the other hand, for an amorphous alloy ribbon before crystallization of a nanocrystalline alloy ribbon, while the punching work can be performed on the amorphous alloy ribbons one by one, the amorphous alloy ribbon is extremely thin having a plate thickness of one ribbon of about 20 μm. Therefore, since a clearances between a punch and a die as dies for the punching work needs to be reduced to about 1 μm to 2 μm, abrasion of the punch and the die increases. Further, since the amorphous alloy ribbon has a high hardness without a crystal interface as a starting point of deformation of a material, the abrasion of the punch and the die increases. Therefore, even with a method in which an alloy ribbon piece is formed by performing a punching work of an amorphous alloy ribbon and then the alloy ribbon piece is crystallized to manufacture a nanocrystalline alloy ribbon piece, the manufacture is not easy, and the punch and the die wear out quickly. Consequently, the productivity is reduced compared with a case of using a magnetic steel sheet.

The present disclosure is made in view of these points, and provides a method for manufacturing an alloy ribbon piece containing a nanocrystalline alloy capable of facilitating the manufacture of the alloy ribbon piece by a punching work of an alloy ribbon.

To solve the above-described problems, a method for manufacturing an alloy ribbon piece of the present disclosure is a method for manufacturing an alloy ribbon piece containing a nanocrystalline alloy. The method comprises: preparing an alloy ribbon containing an FeNiB-based amorphous alloy; heating a processing planned portion at a circumference of a crystallization planned portion that is an area in which the alloy ribbon piece is punched of the alloy ribbon to a first temperature range in which crystal grains of αFe and crystal grains of Fe₂B deposit to cause the crystal grains of αFe and the crystal grains of Fe₂B to deposit, and simultaneously heating the crystallization planned portion to a second temperature range of a crystallization starting temperature or higher and lower than the first temperature range to crystallize the crystallization planned portion; and punching an area including the crystallization planned portion from the alloy ribbon by shearing the processing planned portion of the alloy ribbon after the heating to form the alloy ribbon piece.

### Effect

According to the present disclosure, the alloy ribbon piece can be easily manufactured by the punching work of the alloy ribbon.

### BRIEF DESCRIPTION OF THE DRAWINGS

FIG. 1A and FIG. 1B are schematic process perspective views illustrating a method for manufacturing an alloy ribbon piece according to one embodiment;

FIG. 2A and FIG. 2B are schematic process perspective views illustrating the method for manufacturing an alloy ribbon piece according to the one embodiment;

FIG. 3A and FIG. 3B are schematic process perspective views illustrating the method for manufacturing an alloy ribbon piece and a method for manufacturing a stator core using the alloy ribbon piece according to the one embodiment;

FIG. 4 is a graph illustrating a DSC curve of an FeNiB-based amorphous alloy contained in an alloy ribbon used in Reference Examples 1 and 2;

FIG. 5A and FIG. 5B are photographs illustrating punching tests of Reference Examples 1 and 2, respectively;

FIG. 6A is a graph illustrating X-ray diffraction patterns of the alloy ribbon after thermal processing of Reference Examples 1 and 2;

FIG. 6B is a structure image of the alloy ribbon after the thermal processing of Reference Example 1 observed at magnifications of 5000× to 20000× with an SEM; and

FIG. 6C is a schematic diagram of a structure of the alloy ribbon after the thermal processing of Reference Example 2.

### DETAILED DESCRIPTION OF THE EMBODIMENTS

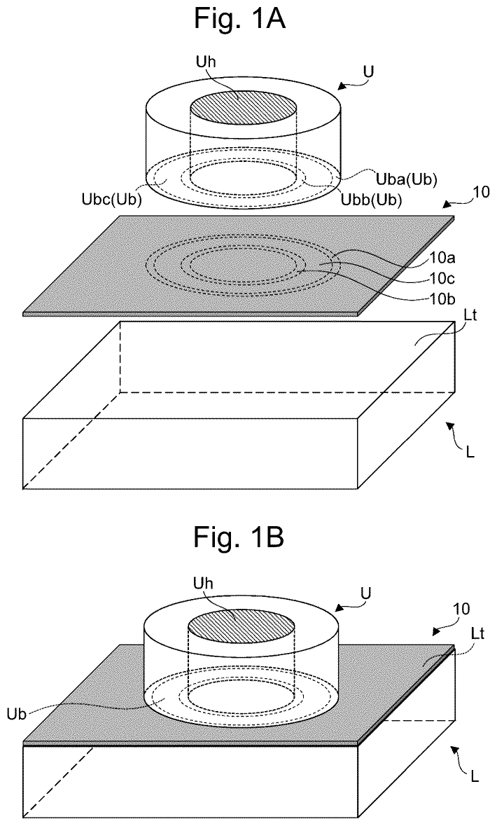

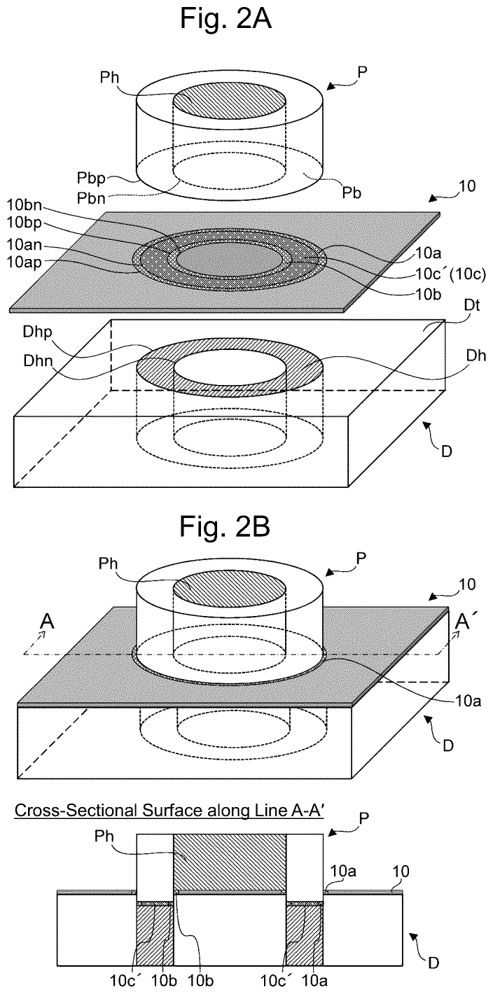

First, an outline of a method for manufacturing an alloy ribbon piece according to an embodiment is described with an example of one embodiment. The method for manufacturing an alloy ribbon piece according to the one embodiment is a method for manufacturing a ring-shaped alloy ribbon piece constituting a laminate used for a stator core of a motor. FIG. 1A to FIG. 3B are schematic process perspective views illustrating the method for manufacturing an alloy ribbon piece and a method for manufacturing a stator core using the alloy ribbon piece according to the one embodiment, and FIG. 2B illustrates a schematic cross-sectional view illustrating a cross-sectional surface along a line A-A′ in the perspective view together.

In the method for manufacturing an alloy ribbon piece according to the one embodiment, first, as illustrated in FIG. 1A, an alloy ribbon 10 is prepared (preparation step). Then, the alloy ribbon 10 is located between a bottom surface (heating surface) Ub of an upper thermal processing die U and a top surface (support surface) Lt of a lower thermal processing die L (first locating step). The alloy ribbon 10 is an alloy ribbon containing an FeNiB-based amorphous alloy. The upper thermal processing die U is a die having an approximately columnar shape with a columnar through-hole Uh at the center and having an annular bottom surface Ub. The upper thermal processing die U internally includes a heater (not illustrated) that can set a heating temperature for each portion of the bottom surface Ub. The bottom surface Ub of the upper thermal processing die U has an outer edge portion Uba and an inner edge portion Ubb preliminarily heated at a heating temperature of 650° C. or higher and 700° C. or lower by the heater, and a center portion Ubc (portion excluding the outer edge portion Uba and the inner edge portion Ubb of the bottom surface Ub) preliminarily heated at a heating temperature of 490° C. or higher and 520° C. or lower by the heater. The outer edge portion Uba, the inner edge portion Ubb, and the center portion Ubc of the bottom surface Ub of the upper thermal processing die U have shapes and dimensions same as those of an outer peripheral processing planned portion 10a, an inner peripheral processing planned portion 10b, and a crystallization planned portion 10c, respectively when the alloy ribbon 10 is viewed in plan view from a thickness direction. Meanwhile, the lower thermal processing die L is a plate-shaped die having a top surface Lt on which the alloy ribbon 10 is located.

Next, as illustrated in FIG. 1B, the alloy ribbon 10 is located on the top surface Lt of the lower thermal processing die L in an atmosphere at room temperature. In this state, in the alloy ribbon 10, the annular crystallization planned portion 10c that is an area in which an alloy ribbon piece is punched, the annular outer peripheral processing planned portion 10a at a circumference in an outer peripheral side of the crystallization planned portion 10c, and the annular inner peripheral processing planned portion 10b at a circumference in an inner peripheral side of the crystallization planned portion 10c are sandwiched between the bottom surface Ub of the upper thermal processing die U and the top surface Lt of the lower thermal processing die L. At this time, the outer edge portion Uba, the inner edge portion Ubb, and the center portion Ubc of the bottom surface Ub of the upper thermal processing die U are pressed against the outer peripheral processing planned portion 10a, the inner peripheral processing planned portion 10b, and the crystallization planned portion 10c of the alloy ribbon 10, respectively for a predetermined time (for example, 3 seconds). Thus, in the alloy ribbon 10, the outer peripheral processing planned portion 10a and the inner peripheral processing planned portion 10b are heated to a first temperature range (first temperature range in which crystal grains of αFe and crystal grains of Fe₂B deposit) of 600° C. or higher and 650° C. or lower and kept to the first temperature range, and at the same time, the crystallization planned portion 10c is heated to a second temperature range (second temperature range of a crystallization starting temperature or higher and lower than the first temperature range) of 470° C. or higher and 500° C. or lower and kept to the second temperature range, thereby performing rapid thermal processing (thermal processing step). Thus, crystallization of the outer peripheral processing planned portion 10a and the inner peripheral processing planned portion 10b of the alloy ribbon 10 is advanced to cause coarse crystal grains of αFe and crystal grains of Fe₂B to densely deposit. At the same time, the crystallization planned portion 10c of the alloy ribbon 10 is crystallized to cause nanocrystalline grains of αFe to deposit, thereby generating a crystallized portion 10c′ (illustrated in FIG. 2A) in which an amorphous alloy in the crystallization planned portion 10c is transformed into a nanocrystalline alloy.

Next, as illustrated in FIG. 2A, the alloy ribbon 10 after the rapid thermal processing is located between a bottom surface (punch surface) Pb of a punch (upper die) P and a top surface (support surface) Dt of a die (lower die) D (second locating step). The punch P is a die having an approximately columnar shape with a columnar through-hole Ph at the center and having an annular bottom surface Pb. The die D is a die provided with a die hole Dh to which the punch P enters from the top surface Dt side. The die hole Dh is a hole penetrating the die D in a direction perpendicular to the top surface Dt of the die D. The die hole Dh has an annular shape approximately the same as the bottom surface Pb of the punch P, and has an outer edge Dhp larger than an outer edge Pbp of the bottom surface Pb of the punch P by an amount of a clearance, and an inner edge Dhn smaller than an inner edge Pbn of the bottom surface Pb of the punch P by an amount of a clearance. In the punch P and the die D, the outer edge Pbp of the bottom surface Pb of the punch P and the outer edge Dhp of the die hole Dh of the die D have shapes and dimensions fitted between an outer edge 10ap and an inner edge 10an of the outer peripheral processing planned portion 10a of the alloy ribbon 10, and the inner edge Pbn of the bottom surface Pb of the punch P and the inner edge Dhn of the die hole Dh of the die D have shapes and dimensions fitted between an outer edge 10bp and an inner edge 10bn of the inner peripheral processing planned portion 10b of the alloy ribbon 10. That is, dimensions of a diameter of the outer edge Pbp of the bottom surface Pb of the punch P and a diameter of the outer edge Dhp of the die hole Dh of the die D are between a diameter of the outer edge 10ap and a diameter of the inner edge 10an of the outer peripheral processing planned portion 10a of the alloy ribbon 10. Dimensions of a diameter of the inner edge Pbn of the bottom surface Pb of the punch P and a diameter of the inner edge Dhn of the die hole Dh of the die D are between a diameter of the outer edge 10bp and a diameter of the inner edge 10bn of the inner peripheral processing planned portion 10b of the alloy ribbon 10.

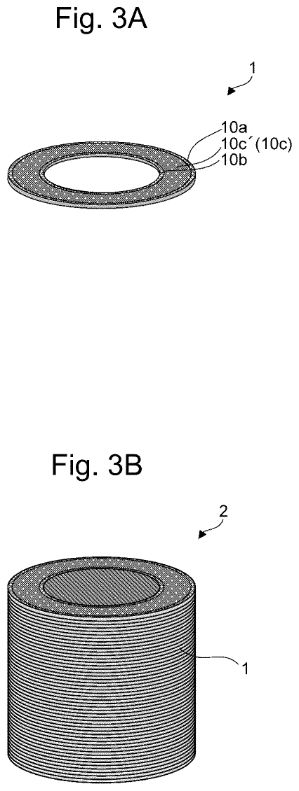

Next, as illustrated in FIG. 2B, the alloy ribbon 10 is sandwiched between the bottom surface Pb of the punch P and the top surface Dt of the die D, and a punching work is performed. In this time, the punch P and the die D are pressed against the alloy ribbon 10 from both sides in a manner in which the outer edge Pbp of the bottom surface Pb of the punch P and the outer edge Dhp of the die hole Dh of the die D contact a portion within a range of the outer peripheral processing planned portion 10a of the alloy ribbon 10 and the inner edge Pbn of the bottom surface Pb of the punch P and the inner edge Dhn of the die hole Dh of the die D contact a portion within a range of the inner peripheral processing planned portion 10b of the alloy ribbon 10, thereby inserting the bottom surface Pb of the punch P into the die hole Dh of the die D. Thus, after the thermal processing step, the outer peripheral processing planned portion 10a and the inner peripheral processing planned portion 10b of the alloy ribbon 10 are sheared at positions apart from boundaries (the inner edge 10an of the outer peripheral processing planned portion 10a and the outer edge 10bp of the inner peripheral processing planned portion 10b) with the crystallization planned portion 10c, thereby punching an area including a part of the outer peripheral processing planned portion 10a and a part of the inner peripheral processing planned portion 10b at the crystallized portion 10c′ side from the alloy ribbon 10 together with the crystallized portion 10c′ (crystallization planned portion 10c). Accordingly, as illustrated in FIG. 3A, an alloy ribbon piece 1 including the crystallized portion 10c′ containing the nanocrystalline alloy and a part of the outer peripheral processing planned portion 10a and a part of the inner peripheral processing planned portion 10b at the crystallized portion 10c′ side is formed (punching step). As described above, the alloy ribbon piece 1 containing the nanocrystalline alloy is manufactured. In a method for manufacturing a stator core using the alloy ribbon piece according to the one embodiment, as illustrated in FIG. 3B, a plurality of the alloy ribbon pieces 1 manufactured by the method for manufacturing an alloy ribbon piece according to the one embodiment are stacked, and the alloy ribbon pieces 1 are mutually fixed via adhesive layers (not illustrated) of a heat resistant resin or the like. Thus, a stator core 2 including a laminate of the alloy ribbon pieces 1 is manufactured.

In the method for manufacturing an alloy ribbon piece according to the one embodiment, in the thermal processing step, the crystallization of the outer peripheral processing planned portion 10a and the inner peripheral processing planned portion 10b of the alloy ribbon 10 is advanced to cause coarse crystal grains of αFe and crystal grains of Fe₂B to densely deposit. At the same time, the crystallization planned portion 10c of the alloy ribbon 10 is crystallized to cause nanocrystalline grains of αFe to deposit, thereby generating the crystallized portion 10c′ in which the amorphous alloy in the crystallization planned portion 10c is transformed into the nanocrystalline alloy. Accordingly, in the punching step after the thermal processing step, in the outer peripheral processing planned portion 10a and the inner peripheral processing planned portion 10b of the alloy ribbon 10, different from an amorphous alloy ribbon or a nanocrystalline alloy ribbon, the interface between the crystal grains in the structure in which both of the coarse crystal grains of αFe and the crystal grains of Fe₂B densely deposit can serve as a starting point of plastic deformation, and the hardness is low. Therefore, when the outer peripheral processing planned portion 10a and the inner peripheral processing planned portion 10b of the alloy ribbon 10 are sheared to punch the area including the crystallized portion 10c′ (crystallization planned portion 10c) from the alloy ribbon 10, the shearing can be easily performed. Furthermore, the alloy ribbon piece 1 including the crystallized portion 10c′ containing the nanocrystalline alloy capable of having both high magnetization and low coercive force can be formed. Accordingly, the method for manufacturing an alloy ribbon piece according to the one embodiment can facilitate the manufacture of the alloy ribbon piece 1 containing the nanocrystalline alloy capable of having both high magnetization and low coercive force by the punching work of the alloy ribbon 10. This allows reduction of the wear of dies (punch and die) for the punching work, and therefore, the productivity of the alloy ribbon piece 1 can be improved.

Subsequently, a configuration of the method for manufacturing an alloy ribbon piece according to the embodiment is described in detail.

### 1. Preparation Step

In the preparation step, an alloy ribbon containing an FeNiB-based amorphous alloy is prepared.

While the alloy ribbon is not specifically limited insofar as an FeNiB-based amorphous alloy is contained, the alloy ribbon is, for example, a continuous sheet-shaped amorphous alloy ribbon manufactured by a common method, such as a single-roll process or a twin-roll process. The FeNiB-based amorphous alloy is not specifically limited insofar as an amorphous alloy containing Fe (iron), Ni (nickel), and B (boron) as main components is used. As the composition of the FeNiB-based amorphous alloy, Si (silicon) is further contained in the composition in some embodiments, and specifically, for example, a composition represented by a general formula (1) below is used in some embodiments.

Fe_{100-x-y-z-w}BₓNi_{y}Si_{z}M_{w} (1)

(In the formula, M is one or more inevitable elements selected from Nb (niobium), Mo (molybdenum), Ta (tantalum), W (tungsten), Co (cobalt), and Sn (tin), and x, y, z, and w satisfy conditions of 12≤x≤17, 1≤y≤3, 0<z≤1, and 0<w≤0.1 by atomic percent.)

Although not specifically limited, for example, the thickness of the alloy ribbon is in a range of 10 μm or more and 100 μm or less, and may be in a range of 20 μm or more and 50 μm or less.

### 2. Thermal Processing Step

In the thermal processing step, in the alloy ribbon, the processing planned portion at the circumference of the crystallization planned portion that is an area in which the alloy ribbon piece is punched is heated to the first temperature range in which crystal grains of αFe and crystal grains of Fe₂B deposit to cause the crystal grains of αFe and the crystal grains of Fe₂B to deposit, and simultaneously, the crystallization planned portion is heated to the second temperature range of the crystallization starting temperature or higher and lower than the first temperature range to crystallize the crystallization planned portion.

Here, the “crystallization planned portion” means a portion that becomes an area (alloy ribbon piece) punched from the alloy ribbon in the punching step, and may be a portion included in the area punched from the alloy ribbon. The “processing planned portion” means a portion at the circumference of the crystallization planned portion, and means a portion extending outward from the edge of the crystallization planned portion by a predetermined width. While the width of the processing planned portion is not specifically limited insofar as a damage, such as a crack, leading to a quality problem does not occur during the punching in the punching step, the width of the processing planned portion may be, for example, 1 mm or more. This is because the lower limit or more allows effectively suppressing occurrence of a damage, such as a crack. The width of the processing planned portion may be small as much as possible. This is because the magnetic property of the alloy ribbon piece can be improved by increasing the proportion of the crystallized crystallization planned portion in the area punched from the alloy ribbon in the punching step. Here, the “width of the processing planned portion” means a dimension in a direction perpendicular to the edge of the processing planned portion.

The “crystallization starting temperature” means a temperature at which the crystallization of the alloy ribbon starts when the alloy ribbon containing the FeNiB-based amorphous alloy is heated. The crystallization of the alloy ribbon means to cause crystal grains of αFe (ferrite phase) to deposit. While the crystallization starting temperature differs depending on the composition of the FeNiB-based amorphous alloy, the crystallization starting temperature is, for example, 350° C. or higher and 500° C. or lower when the composition of the FeNiB-based amorphous alloy is the above-described composition in some embodiments.

The first temperature range is not specifically limited to insofar as the first temperature range is a temperature range in which both of crystal grains of αFe and crystal grains of Fe₂B deposit, and differs depending on the composition of the FeNiB-based amorphous alloy. However, for example, the first temperature range may be 600° C. or higher and 650° C. or lower when the composition of the FeNiB-based amorphous alloy is the above-described composition of some embodiments. This is because both of crystal grains of αFe and crystal grains of Fe₂B can densely deposit. The term that “the processing planned portion is heated to the first temperature range in which crystal grains of αFe and crystal grains of Fe₂B deposit to cause the crystal grains of αFe and the crystal grains of Fe₂B to deposit” means that the processing planned portion is heated to the first temperature range and maintained in the first temperature range for a time necessary to cause the crystal grains of αFe and the crystal grains of Fe₂B to deposit. While the time of maintaining the processing planned portion in the first temperature range is not specifically limited insofar as the crystal grains of αFe and the crystal grains of Fe₂B can deposit in the processing planned portion without a damage, such as a crack, during the punching, the time of maintaining the processing planned portion in the first temperature range may be, for example, in a range of 2 seconds or more and 4 seconds or less. This is because the lower limits or more of these ranges allow the crystal grains of αFe and the crystal grains of Fe₂B to densely deposit in the processing planned portion. Further, this is because the upper limits or less of these ranges allow suppressing coarsening of the crystal grains of αFe.

While the second temperature range is not specifically limited insofar as the second temperature range is a temperature range of equal to or higher than the crystallization starting temperature and lower than the first temperature range, the second temperature range may be a temperature range of equal to or higher than the crystallization starting temperature and lower than a compound phase deposition starting temperature. This is because the deposition of a compound phase can be suppressed. Here, the “compound phase deposition starting temperature” means a temperature at which the deposition of a compound phase starts when the alloy ribbon after the crystallization start is further heated. The “compound phase” means, for example, a compound phase that deposits when the alloy ribbon after the crystallization start is further heated and deteriorates a soft magnetic property, and the “compound phase” includes various kinds of phases in addition to Fe₂B described above. While such a temperature range of the second temperature range differs depending on the composition of the FeNiB-based amorphous alloy, the second temperature range may be 470° C. or higher and 500° C. or lower, for example, when the composition of the FeNiB-based amorphous alloy is the above-described composition of some embodiments. This is because nanocrystalline grains of αFe can stably deposit, and coarsening of crystal grains and deposition of a compound phase can be suppressed. The term that “the crystallization planned portion is heated to the second temperature range of the crystallization starting temperature or higher and lower than the first temperature range to crystallize the crystallization planned portion” means heating the crystallization planned portion to the second temperature range and maintaining the crystallization planned portion in the second temperature range for a time necessary for the crystallization to crystallize the crystallization planned portion. While the time of maintaining the crystallization planned portion in the second temperature range is not specifically limited insofar as nanocrystalline grains of αFe can deposit in the crystallization planned portion such that both of the high magnetization and the low coercive force can be provided, the time of maintaining the processing planned portion in the second temperature range may be, for example, a time similar to the time of maintaining the processing planned portion in the first temperature range, and specifically, may be in a range of 2 seconds or more and 4 seconds or less. This is because the lower limits or more of these ranges allow the nanocrystalline grains of αFe to stably deposit in the crystallization planned portion. This is because the upper limits or less of these ranges allow suppressing coarsening of the crystal grains of αFe.

While the method for causing the crystal grains of αFe and the crystal grains of Fe₂B to deposit by heating the processing planned portion to the first temperature range and simultaneously crystallizing the crystallization planned portion by heating the crystallization planned portion to the second temperature range is not specifically limited, examples of the method include a method in which a processing planned portion and a crystallization planned portion of an alloy ribbon are sandwiched between a heating surface of an upper thermal processing die and a support surface of a lower thermal processing die in an atmosphere at room temperature as described in the one embodiment. In this method, the lower thermal processing die is not preheated, and the edge portion and the center portion of the heating surface of the upper thermal processing die are preliminarily heated, then, when the processing planned portion and the crystallization planned portion of the alloy ribbon are sandwiched between the heating surface of the upper thermal processing die and the support surface of the lower thermal processing die, the edge portion and the center portion of the heating surface of the upper thermal processing die are pressed against the processing planned portion and the crystallization planned portion of the alloy ribbon for a predetermined time, respectively. The “room temperature” is, for example, a temperature specified in Japanese Industrial Standard Z 8703.

In the thermal processing step, the processing planned portion is heated to the first temperature range to cause the crystal grains of αFe and the crystal grains of Fe₂B to deposit in the processing planned portion. At this time, the processing planned portion may be one having a low hardness in which the crystal grains of αFe and the crystal grains of Fe₂B densely deposit to allow the interface between the crystal grains to function as a starting point of plastic deformation. By heating the crystallization planned portion to the second temperature range to crystallize the crystallization planned portion, a crystallized portion containing the nanocrystalline alloy is obtained. In this time, the crystallized portion may be provided with desired magnetic properties (high magnetization and low coercive force) by causing the nanocrystalline grains of αFe to deposit without substantially causing the deposition of the compound phase and the coarsening of the crystal grains. While the particle size of the crystal grains of αFe in the crystallized portion is not specifically limited insofar as the desired magnetic properties are obtained, the particle size of the crystal grains of αFe in the crystallized portion may be, for example, in a range of 25 nm or less. This is because coarsening deteriorates the coercive force. The particle size of the crystal grains can be measured, for example, by a direct observation using a scanning electron microscope (SEM).

### 3. Punching Step

In the punching step, after the thermal processing step, the processing planned portion of the alloy ribbon is sheared to punch the area including the crystallization planned portion from the alloy ribbon, thereby forming the alloy ribbon piece. While the punching step is not specifically limited insofar as the punching step is a step in which the processing planned portion is sheared to punch the area including the crystallization planned portion from the alloy ribbon, for example, as described in the one embodiment, the punching step may be a step in which the processing planned portion is sheared at a position apart from the boundary with the crystallization planned portion to punch the area including a part of the processing planned portion at the crystallization planned portion side from the alloy ribbon together with the crystallization planned portion. This is because occurrence of a damage, such as a crack, during the punching can be suppressed.

While the method for punching the crystallization planned portion from the alloy ribbon is not specifically limited, examples of the method include a method in which a punch and a die are used and a punching work is performed with an alloy ribbon sandwiched between a punch surface of the punch and a support surface of the die as described in the one embodiment. While the punch and the die are not specifically limited insofar as an area in a desired shape including the crystallization planned portion can be punched, the punch and the die have the shapes and the dimensions such that the edge of the punch surface of the punch and the edge of the die hole of the die is fitted between the edges of the processing planned portion of the alloy ribbon in some embodiments as described in the one embodiment. In the method for performing the punching work, for example, as described in the one embodiment, using the punch and the die in some embodiments, the punch and the die may be pressed against the alloy ribbon from both sides to insert the punch into the die hole of the die in a manner in which the edge of the punch surface of the punch and the edge of the die hole of the die contact a portion within a range of the processing planned portion of the alloy ribbon. This is because the area including a part of the processing planned portion at the crystallization planned portion side can be punched from the alloy ribbon together with the crystallization planned portion, thereby allowing suppressing occurrence of a damage, such as a crack.

### 4. Method for Manufacturing Alloy Ribbon Piece, and Alloy Ribbon Piece

The method for manufacturing an alloy ribbon piece is not specifically limited to insofar as the preparation step, the thermal processing step, and the punching step are included, and another step may be included. While the alloy ribbon piece manufactured by the method for manufacturing an alloy ribbon piece is not specifically limited insofar as the crystallized crystallization planned portion (crystallized portion) is included, for example, a part of the processing planned portion at the crystallization planned portion side may be included together with the crystallization planned portion like the alloy ribbon piece manufactured in the one embodiment.

### EXAMPLES

The following further specifically describes the embodiments according to the present disclosure with reference examples.

### [DSC Curve of FeNiB-Based Amorphous Alloy]

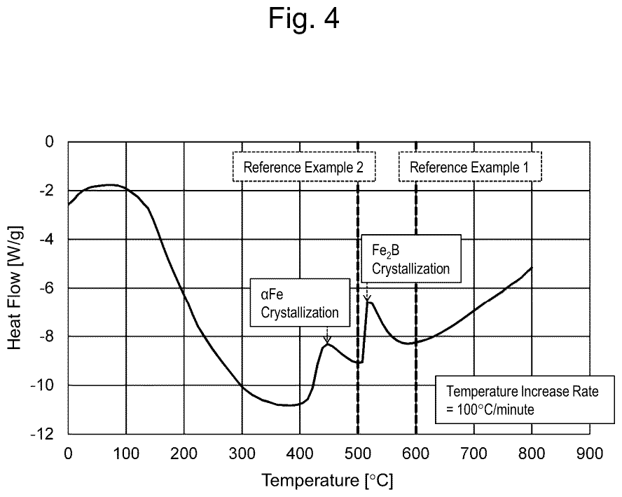

A DSC curve of an FeNiB-based amorphous alloy contained in an alloy ribbon used in Reference Examples 1 and 2 was measured with a differential scanning calorimeter (DSC). As the FeNiB-based amorphous alloy, an alloy having a composition containing 83.7 atomic percents of Fe, 2 atomic percents of Ni, 13.5 atomic percents of B, and 0.8 atomic percents of Si, and the balance of inevitable impurities was used. The temperature increase rate of the FeNiB-based amorphous alloy during the measurement of the DSC curve was 100° C./minute. FIG. 4 is a graph illustrating the DSC curve of the FeNiB-based amorphous alloy contained in the alloy ribbon used in Reference Examples 1 and 2.

In the DSC curve illustrated in FIG. 4, a peak near 450° C. is considered as a heat generation peak of a crystallization reaction that causes nanocrystalline grains of αFe to deposit. A peak near 520° C. is considered as a heat generation peak of a crystallization reaction that causes crystal grains of Fe₂B to deposit. Therefore, in Reference Example 1 described later, 600° C. was selected as a heating temperature to advance the crystallization of the alloy ribbon and cause coarse crystal grains of αFe and crystal grains of Fe₂B to densely deposit. In Reference Example 2 described later, 500° C. was selected as a heating temperature to crystallize the alloy ribbon and cause nanocrystalline grains of αFe to deposit.

### Reference Example 1

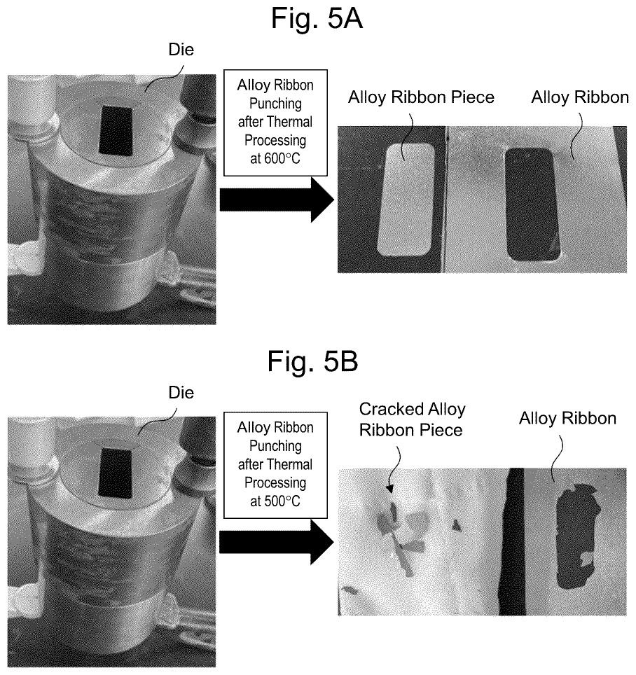

An alloy ribbon was crystallized and a punch test was performed. At this time, first, an alloy ribbon containing the above-described FeNiB-based amorphous alloy was prepared. Next, in an atmosphere at room temperature, a surface of the alloy ribbon was pressed against a surface of a heating plate preliminarily heated at a heating temperature of 650° C. by a heater for 3 seconds, thus performing rapid thermal processing of heating the alloy ribbon to 600° C. and maintaining it in 600° C. Subsequently, as illustrated in FIG. 5A, an approximately rectangular area was punched from the alloy ribbon after the thermal processing using a punch (not illustrated) and a die having approximately rectangular bottom surface (punch surface) of the punch and die hole of the die and having a clearance therebetween of 10 μm. As a result, as illustrated in FIG. 5A, a desired approximately rectangular alloy ribbon piece (metal ribbon piece) was able to be punched without a problem.

### Reference Example 2

An alloy ribbon was crystallized and a punch test was performed. At this time, first, an alloy ribbon containing the FeNiB-based amorphous alloy similar to that of Reference Example 1 was prepared. Next, in an atmosphere at room temperature, a surface of the alloy ribbon was pressed against a surface of a heating plate preliminarily heated at a heating temperature of 520° C. by a heater for 3 seconds, thus performing rapid thermal processing of heating the alloy ribbon to 500° C. and maintaining it in 500° C. Subsequently, as illustrated in FIG. 5B, an approximately rectangular area was punched from the alloy ribbon after the thermal processing using a punch (not illustrated) and a die similar to those of Reference Example 1. As a result, as illustrated in FIG. 5B, the alloy ribbon cracked during the punching, and a desired approximately rectangular alloy ribbon piece was not able to be punched.

### [Evaluation]

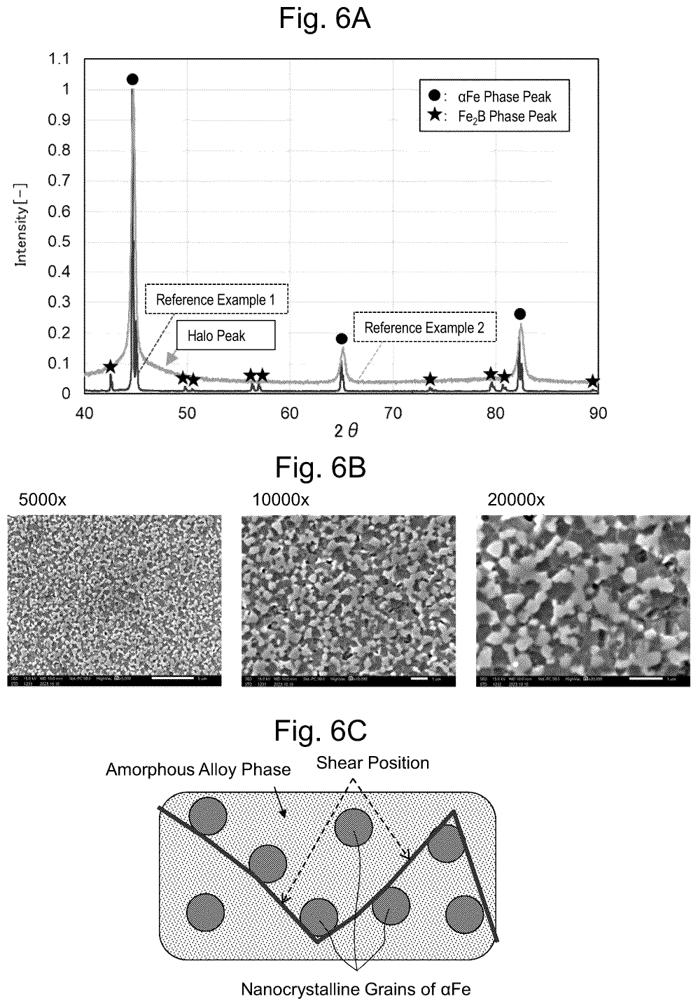

For the alloy ribbons after the thermal processing of Reference Examples 1 and 2, an X-ray diffraction measurement (XRD) was performed and X-ray diffraction patterns were measured. FIG. 6A is a graph illustrating the X-ray diffraction patterns of the alloy ribbons after the thermal processing of Reference Examples 1 and 2. As illustrated in FIG. 6A, in the X-ray diffraction pattern of the alloy ribbon after the thermal processing of Reference Example 1, in addition to peaks of an αFe phase, peaks of an Fe₂B phase can be confirmed. On the other hand, a halo peak derived from an amorphous alloy phase cannot be confirmed. In contrast, in the X-ray diffraction pattern of the alloy ribbon after the thermal processing of Reference Example 2, while peaks of the αFe phase can be confirmed, a peak of the Fe₂B phase cannot be confirmed. On the other hand, a halo peak derived from the amorphous alloy phase can be confirmed. From these contents of the X-ray diffraction pattern, it is considered that the structure of the alloy ribbon after the thermal processing of Reference Example 1 is a mixed phase structure of the αFe phase and the Fe₂B phase without the remaining amorphous alloy phase. In contrast, the structure of the alloy ribbon after the thermal processing of Reference Example 2 is considered to be a mixed phase structure of the amorphous alloy phase and the αFe phase.

For the alloy ribbon after the thermal processing of Reference Example 1, a structure observation was performed with an SEM. FIG. 6B is a structure image of the alloy ribbon after the thermal processing of Reference Example 1 observed at magnifications of 5000× to 20000× with an SEM. From the structure images at the respective magnifications of FIG. 6B, it can be confirmed that in the structure of the alloy ribbon after the thermal processing of Reference Example 1, both the coarse crystal grains (white crystal grains) of αFe and crystal grains (black crystal grains) of Fe₂B densely deposit. On the other hand, while the structure observation with an SEM was not performed on the alloy ribbon after the thermal processing of Reference Example 2, from a conventional knowledge, the structure is considered to be a mixed phase structure in which the nanocrystalline grains of αFe dispersedly deposit in the amorphous alloy phase as illustrated in FIG. 6C.

Furthermore, for the alloy ribbons after the thermal processing of Reference Examples 1 and 2, 10 test pieces were cut out according to the specification of JIS Z2241 13B, a tensile test was performed on the 10 test pieces, and a mean value of upper yield points [MPa] was obtained. As a result, the mean value (N=10) of the upper yield points obtained from the test pieces of the alloy ribbon after the thermal processing of Reference Example 1 was 515.1 MPa. In contrast, the mean value (N=10) of the upper yield points obtained from the test pieces of the alloy ribbon after the thermal processing of Reference Example 2 was 907.8 MPa. It is considered from this that the alloy ribbon after the thermal processing of Reference Example 1 is more easily plastically deformed than the alloy ribbon after the thermal processing of Reference Example 2.

From the above-described results, it is considered that in the alloy ribbon after the thermal processing of Reference Example 1, as illustrated in the structure image of FIG. 6B, the interface between the crystal grains in the structure in which both the coarse crystal grains of αFe and the crystal grains of Fe₂B densely deposit functioned as a starting point of the plastic deformation, and this facilitated the shear along the edge of the bottom surface of the punch. As a result, it is considered that the desired approximately rectangular alloy ribbon piece was able to be punched without a problem. Further, it is considered that such an alloy ribbon after the thermal processing can reduce the wear of punch and die. On the other hand, it is considered that in the alloy ribbon after the thermal processing of Reference Example 2, as illustrated in FIG. 6C, in the mixed phase structure in which the nanocrystalline grains of αFe dispersedly deposit in the amorphous alloy phase, the interfaces between the nanocrystalline grains of αFe and the amorphous alloy phase are dispersed and irregularly arranged. It is considered that therefore, in spite of that the interfaces between the nanocrystalline grains of αFe and the amorphous alloy phase function as the starting point of the plastic deformation, the shear along the edge of the bottom surface of the punch became difficult. It is considered that as a result, the alloy ribbon cracked during the punching.

While the embodiments according to the method for manufacturing an alloy ribbon piece of the present disclosure have been described above in detail, the present disclosure is not limited to the above-described embodiments, and various kinds of change of design can be made without departing from the spirit of the present disclosure described in the claims.

All publications, patents and patent applications cited in the present description are herein incorporated by reference as they are.

DESCRIPTION OF SYMBOLS

| | |
|---|---|
| 1 | Alloy ribbon piece |
| 10 | Alloy ribbon |
| 10a | Outer peripheral processing planned portion |
| 10b | Inner peripheral processing planned portion |
| 10c | Crystallization planned portion |
| U | Upper thermal processing die |
| L | Lower thermal processing die |
| P | Punch (upper die) |
| D | Die (lower die) |

What is claimed is:

1. A method for manufacturing an alloy ribbon piece containing a nanocrystalline alloy, comprising:
preparing an alloy ribbon containing an FeNiB-based amorphous alloy;
heating a processing planned portion at a circumference of a crystallization planned portion that is an area in which the alloy ribbon piece is punched of the alloy ribbon to a first temperature range in which crystal grains of αFe and crystal grains of Fe₂B deposit to cause the crystal grains of αFe and the crystal grains of Fe₂B to deposit, and simultaneously heating the crystallization planned portion to a second temperature range of a crystallization starting temperature or higher and lower than the first temperature range to crystallize the crystallization planned portion; and
punching an area including the crystallization planned portion from the alloy ribbon by shearing the processing planned portion of the alloy ribbon after the heating to form the alloy ribbon piece.

2. The method for manufacturing an alloy ribbon piece according to claim 1,
wherein in the heating, the first temperature range is 600° C. or higher and 650° C. or lower, and the second temperature range is 470° C. or higher and 500° C. or lower.
